(19) United States
(12) Patent Application Publication
(10) Pub. No.: US 2009/0064267 A1
(43) Pub. Date: Mar. 5, 2009

(54) METHOD AND SYSTEM FOR AUTOMATICALLY ADJUSTING CONTENT RENDERING DEVICE ACCORDING TO CONTENT GENRE

(75) Inventor: Hwa-kyung Lee, Seoul (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 12/137,913

(22) Filed: Jun. 12, 2008

(30) Foreign Application Priority Data
Aug. 30, 2007 (KR) 10-2007-0087678

(51) Int. Cl. H04N 7/16

(52) U.S. Cl. 725/149; 725/151

(57) ABSTRACT

Provided are a method of automatically adjusting content rendering devices according to the genres of content, and a broadcasting system and a receiving system that perform the method. The broadcasting system broadcasts a composite data set that includes content and meta data, the meta data including set values of optimal images and sounds depending on the program genre of the content. The receiving system receives and parses the broadcasted composite data set into the original content and the meta data associated with the original content. The receiving system processes the set values of the optimal images and sounds of the corresponding broadcast genre from the meta data so as to automatically adjust a content rendering device such as a video display system or an audio system. Thus, an optimal visual and audio environment is established.

### CROSS-REFERENCE TO RELATED PATENT APPLICATION

This application claims priority from Korean Patent Application No. 10-2007-0087678, filed on Aug. 30, 2007, in the Korean Intellectual Property Office, the disclosure of which is incorporated herein by reference in its entirety.

### BACKGROUND OF THE INVENTION

1. Field of the Invention

Apparatuses and methods consistent with the present invention relate to broadcasting and rendering broadcast program data, and more particularly, to automatically adjusting a content rendering device according to the genres of programs that are currently being broadcast.

2. Description of the Related Art

Modem broadcasting receivers have automatic video and audio functions that can provide optimized environments for program genres that are currently being broadcast.

An automatic video function allows users to select icons, such as an image for movies, an image for news, an image for music, an image for sports, an image for documentaries, and so on from a menu, according to program genres. The image for movies, the image for news, the image for music, the image for sports, the image for documentaries, and so on have preset attribute values such as brightness, color, color depth, definition, and so on.

Similarly, an automatic audio function allows users to select icons, such as a sound for movies, a sound for news, a sound for music, a sound for sports, a sound for documentaries, and so on from a menu, according to program genres. The sound for movies, the sound for news, the sound for music, the sound for sports, the sound for documentaries, and so on have preset attribute values such as magnitude, balance, volume, and so on.

In order to watch broadcast programs, users select what they desire from an image for movies, an image for news, an image for music, an image for sports, an image for documentaries, a sound for movies, a sound for news, a sound for music, a sound for sports, a sound for documentaries, and so on, each having preset attribute values.

For example, movie broadcast programs provide more realistic images and sounds when viewed with a dark screen and a high volume, compared with news or sports broadcast programs. Accordingly, in order to watch movies under optimal conditions, users can directly select an image for movies and a sound for movies which have been set to provide a dark screen and a high volume.

However, these automatic video and audio functions have a disadvantage in that when a program genre being broadcast is changed or a user changes a program genre currently being watched by changing the channel, the user needs to newly set an automatic image and an automatic sound according to the new program genre. For example, when a user changes a channel from a movie channel to a sports channel, the user needs to change the setting from an image for movies and a sound for movies to an image for sports and a sound for sports.

### SUMMARY OF THE INVENTION

The present invention provides a method and apparatus for broadcasting content together with meta data used to control the function of a content rendering device and for rendering the content having the meta data in order to automatically adjust the content rendering device.

The present invention also provides broadcasting and receiving systems for performing the method of automatically adjusting the content rendering device.

According to an aspect of the present invention, there is provided a method of adjusting a content rendering device, the method comprising: producing a composite data set that comprises content and meta data that is used to control functions of a content rendering device for rendering the content; and broadcasting the composite data set to at least one content rendering device.

According to another aspect of the present invention, there is provided a method of adjusting a content rendering device, the method comprising: receiving a composite data set that comprises content and meta data that is used to control functions of a content rendering device for rendering the content; parsing the composite data set into the content and the meta data; generating control signals for controlling the content rendering device, in response to the meta data; and rendering the content by adjusting the content rendering device according to the control signals.

According to another aspect of the present invention, there is provided a method of adjusting a content rendering device, the method comprising: broadcasting a composite data set that comprises content and meta data that is used to control functions of a content rendering device according to a genre of the content; receiving the composite data set; parsing the composite data set into the content and the meta data; generating control signals for controlling the content rendering device, in response to the meta data; and rendering the content by adjusting the content rendering device according to the control signals.

According to another aspect of the present invention, there is provided a broadcasting system comprising: a content source; a meta data source which controls functions of a content rendering device for rendering content; a combiner which combines the content source with the meta data source in order to form a composite data set; and a broadcast device which broadcasts the composite data set to at least one receiver.

According to another aspect of the present invention, there is provided a receiving system comprising: a receiver which receives a composite data set that comprises content and meta data that is used to control functions of a content rendering device for rendering the content; a parser which parses the composite data set into the content and the meta data; a meta data processor which generates control signals for controlling the content rendering device, in response to the meta data; and the content rendering device which renders the content according to the control signals.

According to another aspect of the present invention, there is provided a system comprising: a content source; a meta data source which controls functions of a content rendering device according to the genre of content; a combiner which combines the content source with the meta data source in order to form a composite data set; a broadcast device which broadcasts the composite data set; a receiver which receives the composite data set; a parser parsing the composite data set into the content and the meta data; a meta data processor which generates control signals for controlling the content rendering device, in response to the meta data; and the content rendering device which renders the content according to the control signals.

The meta data may include set values of images and sounds for each genre of the content.

The meta data may index the types of scenes included in the content and comprise the set values of images and sounds for each genre of the content according to the scene types.

The content rendering device may be one of a video display system, an audio system, a recording system, and appliances located on a home network.

The meta data may include at least one of data associated with generation of content, meta data associated with the format of the content, meta data about materials associated with the content, and data defined by the writer of the content.

### BRIEF DESCRIPTION OF THE DRAWINGS

The above and other features of the present invention will become more apparent by describing in detail exemplary embodiments thereof with reference to the attached drawings in which:

FIG. 1 is a block diagram illustrating a broadcasting system and a receiving system according to an exemplary embodiment of the present invention;

FIG. 2 illustrates a meta data source illustrated in FIG. 1;

FIG. 3 illustrates a structure of the meta data source illustrated in FIG. 1 combined with a content source shown in FIG. 1, according to an exemplary embodiment of the present invention;

FIG. 4 illustrates a structure of the meta data source illustrated in FIG. 1 combined with the content source illustrated in FIG. 1, according to another exemplary embodiment of the present invention; and

FIG. 5 is a flowchart illustrating a method of automatically adjusting images and sounds according to program genres by using the broadcasting and receiving systems illustrated in FIG. 1.

### DETAILED DESCRIPTION OF THE INVENTION

The attached drawings for illustrating exemplary embodiments of the present invention are referred to in order to gain a sufficient understanding of the present invention, the merits thereof, and the objectives accomplished by the implementation of the present invention.

Hereinafter, the exemplary embodiments of the present invention will be described in detail with reference to the attached drawings. Like reference numerals in the drawings denote like elements.

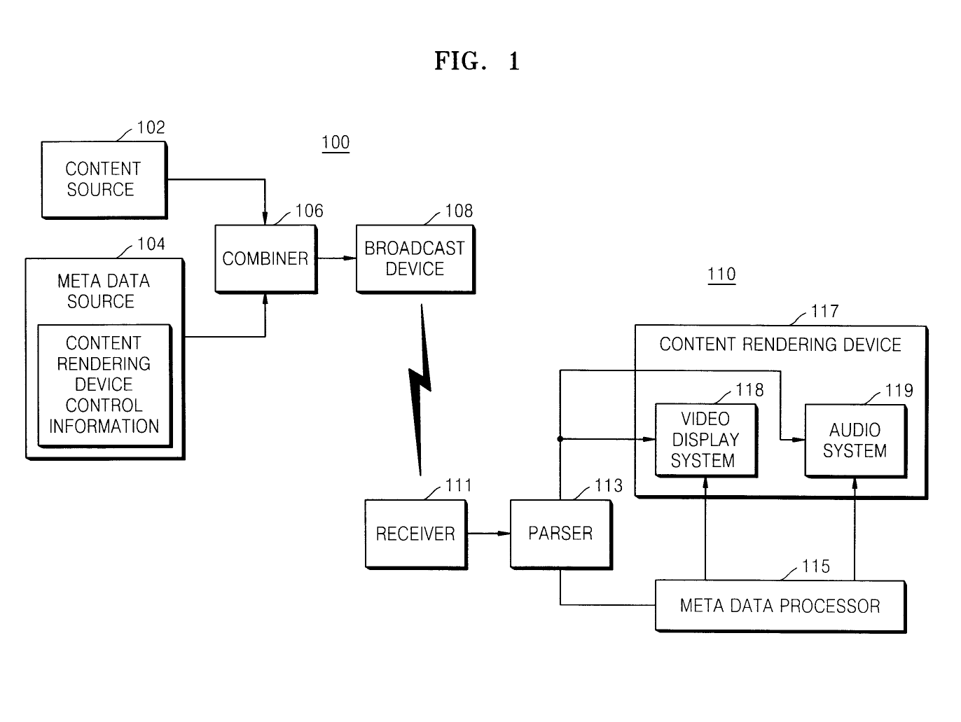

FIG. 1 is a block diagram illustrating a broadcasting system 100 and a receiving system 110 according to an embodiment of the present invention. Referring to FIG. 1, the broadcasting system 100 includes a content source 102, a meta data source 104, a combiner 106, and a broadcast device 108.

The content source 102 includes a plurality of segments of broadcasting program data such as movies, songs, sports, news, entertainment programs, and so on.

The meta data source 104 includes information associated with the content source 102. Meta data denotes structured data that includes meta data associated with generation of content, meta data associated with the format of the content, meta data about materials associated with the content, and other meta data defined by the writer of the content.

The meta data associated with the generation of the content may include the name of a title, the type of title, and information about organizations involved in the manufacture, distribution, etc. of the title. The meta data associated with the format of the content may include credits, promotional information, the type of content, a review of the content, and so on. The credits are information about people associated with the manufacture of the title. As for movie content, the credits are information associated with actors and actresses, directors, producers, music producers, screen writers, etc, and the promotional information is information about genres, languages, a parental guide (e.g., no one 17 and under admitted), and so on. The meta data about the materials associated with the content may include a synopsis, information about awarding or non-awarding, a universal resource locator (URL) address of related information, and so on.

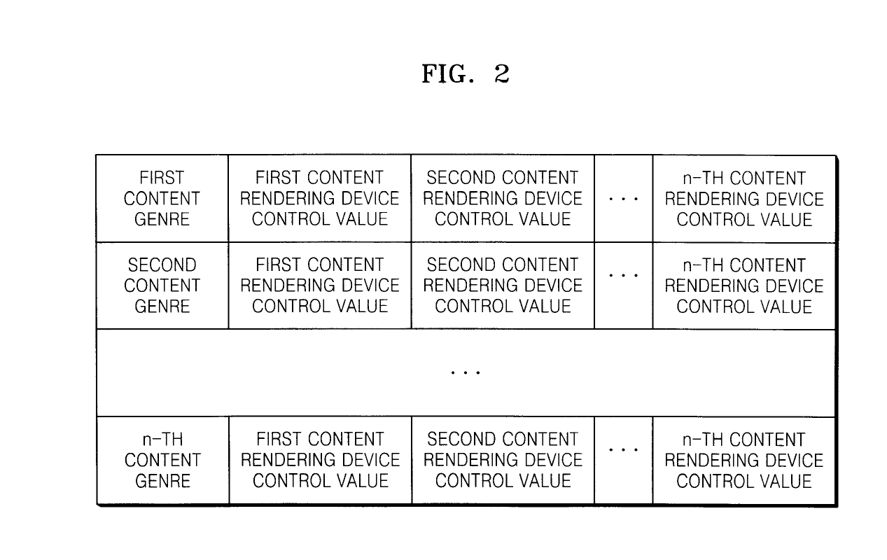

The meta data source 104 includes content rendering device control information used to produce optimal images and sounds according to content genres (or styles). For example, as illustrated in FIG. 2, if a first content genre is a movie, meta data is set to have a control value that is used to lower a resolution by adjusting the definition so that images look smooth, a control value that is used to slightly decrease the brightness in order to make a movie theater atmosphere, a control value that is used to turn on a stereo mode, a control value that is used to control the frequency characteristics of an audio equalizer so that a low sound is emphasized, and so on. If a second content genre is a sports genre, meta data is set to have a control value used to increase the resolution of images by adjusting the definition, a control value used to slightly increase the brightness, a control value used to turn on a surround sound mode in order to generate realism, a control value used to control the frequency characteristics of the audio equalizer to keep standard frequency characteristics, and so on. The set values of the meta data for optimal images and sounds control content rendering devices that include media devices, such as video players or audio players, which receive broadcast programs.

The meta data source 104 is combined with the content source 102 by the combiner 106 to form a composite data set, and broadcasted via the broadcast device 108. The broadcast device 108 may be a conventional radio or television broadcast device, such as an RF transmitter or a cable or satellite headend transmitter, or may be a server on the Internet or other network that provides live feeds (“streaming” audio and/or video material). The broadcast device 108 may include an interface to a broadcasting service provider.

Referring back to FIG. 1, the receiving system 110 includes a receiver 111, a parser 113, a meta data processor 115, and a content rendering device 117.

The receiver 111 is any of a variety of means for receiving the composite data set that is communicated from the broadcast device 108. The receiver 111 includes, for example, an RF receiver, a satellite receiver, a cable signal receiver, a web access device, a playback device, and so on.

The parser 113 parses the composite data set received by the receiver 111 into the original content and the meta data associated with the original content.

The meta data processor 115 accesses the set values of the meta data for optimal images and sounds of a corresponding broadcast program genre and generates video and audio signals for controlling the content rendering device 117.

For example, when the genre of a broadcast program is a movie, the meta data processor 115 generates a definition control signal for lowering the resolution of images so that an image looks smooth, a brightness control signal for slightly decreasing the brightness of the image in order to produce a movie theater atmosphere, a stereo mode control signal for turning on a stereo mode, and an audio equalizer control signal for controlling the frequency characteristics of an audio equalizer so that a low sound is emphasized. On the other hand, when the genre of a broadcast program is a sports genre, the meta data processor 115 generates a definition control signal for increasing the resolution of images, a brightness control signal for slightly increasing the brightness of images, a surround sound mode control signal for turning on a surround sound mode in order to increase realism, and an audio equalizer control signal for controlling the frequency characteristics of the audio equalizer to keep standard frequency characteristics.

The content rendering device 117 is any of a variety of conventional devices that are configured to render, or prepare for rendering, or store for future rendering, the received content. The content rendering device 117 includes, for example, a video display system 118, an audio system 119, a recording system (not shown), and/or an interface (not shown) to other systems, such as devices or appliances that are located on a home network (not shown) to which the receiving system 110 has access.

The content rendering device 117 receives the original content from the parser 113 and renders the content according to the video and audio signals generated by the meta data processor 115.

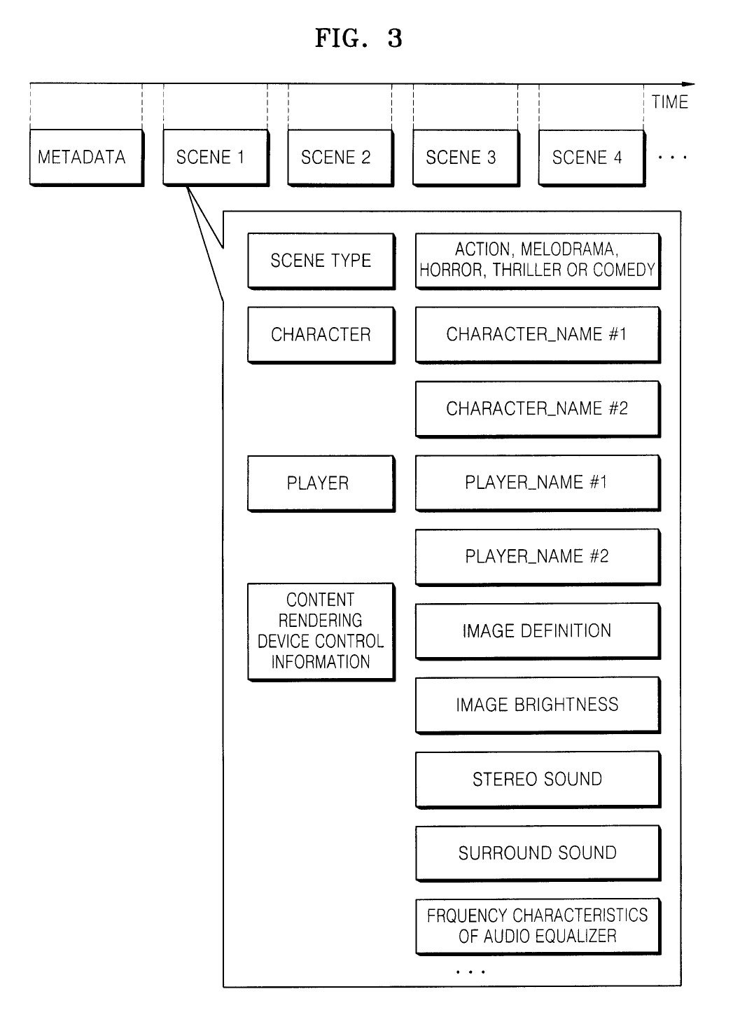

FIG. 3 illustrates a structure of the meta data source 104 combined with the content source 102, according to an embodiment of the present invention. Referring to FIG. 3, the meta data associated with the generation of content, meta data associated with the format of the content, meta data about materials associated with the content, and other meta data defined by the writer of the content are included in a portion at the beginning of the content.

For example, a movie includes a plurality of scenes. Each scene includes search keyword information such as a scene type (for example, action, melodrama, horror, thriller, and comedy), characters, players, and so on, an entry point that indicates the start point of each scene, and meta data in which a rendering duration indicating a period of time while the rendering of each scene continues is defined. Each scene further includes meta data that includes preset content rendering device control information depending on the type of scene, such as image resolution, image brightness, stereo sound, surround sound, and the frequency characteristics of an audio equalizer. Accordingly, the respective scenes of the movie can be watched under optimal video and audio conditions.

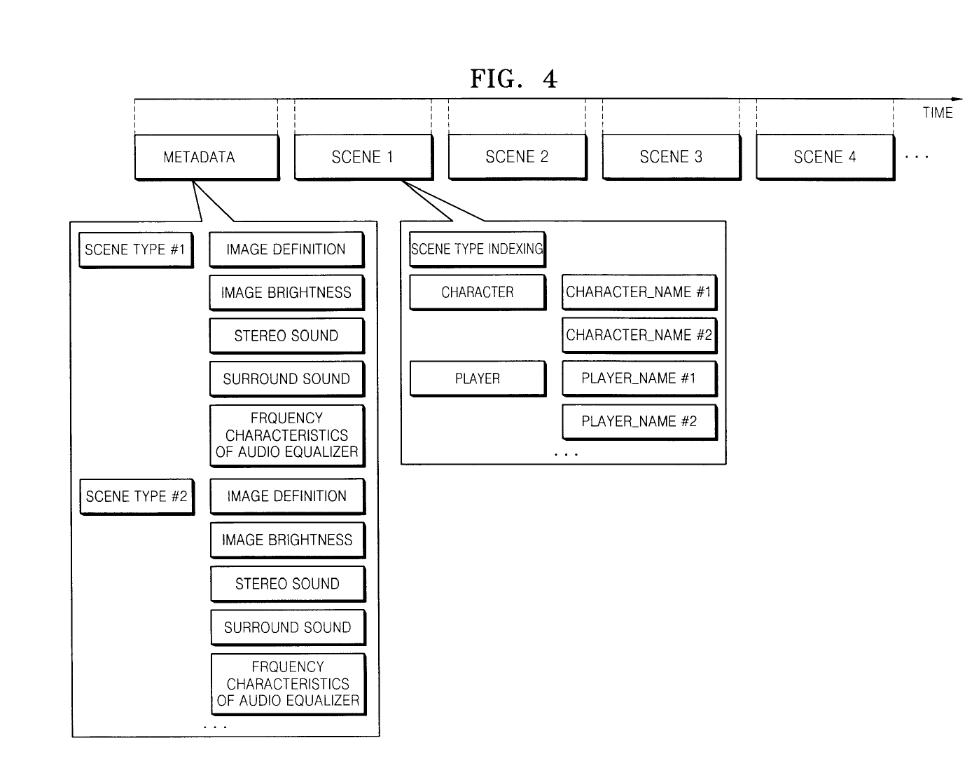

FIG. 4 illustrates a structure of the meta data source 104 combined with the content source 102, according to another embodiment of the present invention. Referring to FIG. 4, meta data located at a portion at the beginning of movie content indexes scene types and further includes content rendering device control data that have been set according to scene types.

For example, when a scene type is action, the meta data located at the portion at the beginning of the movie content indexes the scene type as “#1” and includes a preset control value that is used to increase the resolution of images by adjusting the definition of images, a preset control value that is used to slightly increase the brightness of images, a preset control value that is used to turn on a surround sound mode in order to increase realism, and a preset control value that is used to control the frequency characteristics of an audio equalizer to keep standard frequency characteristics. When a scene type is a melodrama, the meta data located at the portion at the beginning of the movie content indexes the scene type as “#2” and includes a preset control value that is used to decrease the resolution of images by adjusting the definition of images so that images look smooth, a preset control value that is used to slightly decrease the brightness of images, a preset control value that is used to turn on a stereo mode, and a preset control value that is used to control the frequency characteristics of an audio equalizer so that low sounds are emphasized.

Each scene includes search keyword information such as indexing of a corresponding scene type, characters, actors, and so on, an entry point that indicates the start point of each scene, and meta data in which a rendering duration indicating a period of time while the rendering of each scene continues is defined. Each scene is rendered according to the content rendering device control data that has been set according to the scene type indexing in the meta data located at the portion at the beginning of the movie content. Accordingly, the respective scenes of the movie can be watched under optimal video and audio conditions.

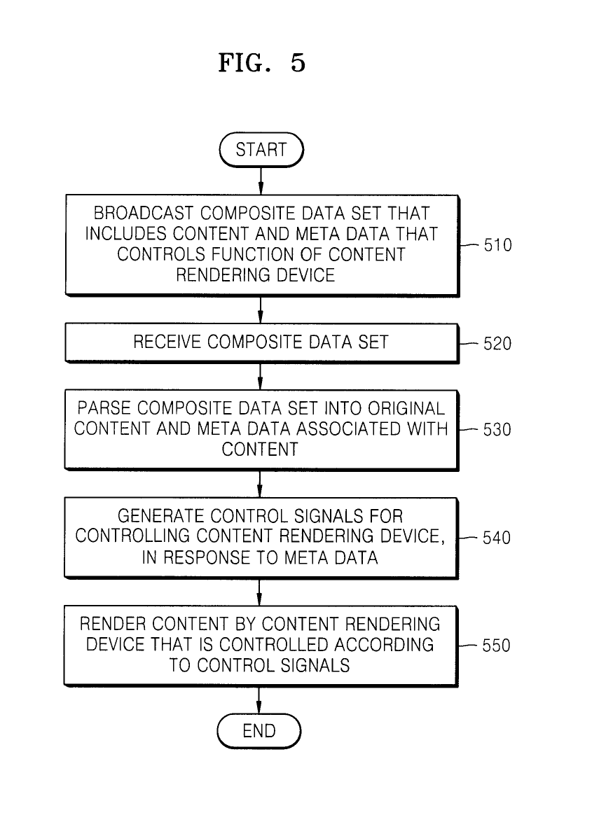

FIG. 5 is a flowchart illustrating a method of automatically adjusting images and sounds according to program genres by using the broadcasting and receiving systems 100 and 110 illustrated in FIG. 1. Referring to FIG. 5, in operation 510, the broadcasting system 100 broadcasts a composite data set that includes content and meta data that controls the function of a content rendering device. In operation 520, the receiving system 110 receives the composite data set. In operation 530, the receiving system 110 parses the composite data set into the original content and the meta data associated with the content. In operation 540, the meta data is processed into control signals for controlling the content rendering device. In operation 550, the content is rendered by content rendering devices that are controlled according to the control signals. Therefore, the content can be rendered by content rendering devices that are controlled to provide optimal conditions that have been set according to the genre of the corresponding content in the meta data.

A method of adjusting a content rendering device according to the present invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, and optical data storage devices. Other storage media may include carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers of ordinary skill in the art to which the present invention pertains.

While the present invention has been particularly shown and described with reference to exemplary embodiments thereof, it will be understood by those of ordinary skill in the art that various changes in form and details may be made therein without departing from the spirit and scope of the present invention as defined by the following claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A method of adjusting a content rendering device, the method comprising:
producing a composite data set that comprises content and meta data, wherein the meta data is used to control functions of a content rendering device which renders the content; and
broadcasting the composite data set to the content rendering device.

2. The method of claim 1, wherein the meta data comprises set values of images and sounds for each genre of the content.

3. The method of claim 2, wherein the meta data indexes scene types included in the content and the set values of images and sounds for each genre of the content are based on the scene types.

4. The method of claim 1, wherein the content rendering device is one of a video display system, an audio system, a recording system, and appliances located on a home network.

5. The method of claim 1, wherein the composite data set is broadcast data.

6. A method of adjusting a content rendering device, the method comprising:
receiving a composite data set that comprises content and meta data, wherein the meta data is used to control functions of a content rendering device which renders the content;
parsing the composite data set into the content and the meta data;
generating control signals which control the content rendering device, in response to the meta data; and
rendering the content by adjusting the content rendering device according to the control signals.

7. The method of claim 6, wherein the meta data comprises set values of images and sounds for each genre of the content.

8. The method of claim 7, wherein the meta data indexes scene types included in the content and the set values of images and sounds for each genre of the content are based on the scene types.

9. The method of claim 6, wherein the content rendering device is one of a video display system, an audio system, a recording system, and appliances located on a home network.

10. The method of claim 6, wherein the composite data set is broadcast data.

11. A method of adjusting a content rendering device, the method comprising:
broadcasting a composite data set that comprises content and meta data, wherein the meta data is used to control functions of a content rendering device according to a genre of the content;
receiving the composite data set;
parsing the composite data set into the content and the meta data;
generating control signals which control the content rendering device, in response to the meta data; and
rendering the content by adjusting the content rendering device according to the control signals.

12. The method of claim 11, wherein the composite data set is broadcast data.

13. A broadcasting system comprising:
a content source which provides content;
a meta data source which provides meta data which control functions of a content rendering device for rendering content;
a combiner which combines the content with the meta data in order to generate a composite data set; and
a broadcast device which broadcasts the composite data set to at least one receiver.

14. The broadcasting system of claim 13, wherein the meta data comprises set values of images and sounds for each genre of the content.

15. The broadcasting system of claim 14, wherein the meta data indexes scene types included in the content and the set values of images and sounds for each genre of the content are based on the scene types.

16. The broadcasting system of claim 13, wherein the content rendering device is one of a video display system, an audio system, a recording system, and appliances located on a home network.

17. The broadcasting system of claim 13, wherein the composite data set is broadcast data.

18. A receiving system comprising:
a receiver which receives a composite data set that comprises content and meta data, wherein the meta data is used to control functions of a content rendering device for rendering the content;
a parser which parses the composite data set into the content and the meta data;
a meta data processor which generates control signals which control the content rendering device, in response to the meta data; and
the content rendering device which renders the content according to the control signals.

19. The receiving system of claim 18, wherein the meta data comprises set values of images and sounds for each genre of the content.

20. The receiving system of claim 19, wherein the meta data indexes scene types included in the content and the set values of images and sounds for each genre of the content are based on the scene types.

21. The receiving system of claim 18, wherein the content rendering device is one of a video display system, an audio system, a recording system, and appliances located on a home network.

22. The receiving system of claim 18, wherein the composite data set is broadcast data.

23. A system comprising:
a content source which provides content;
a meta data source which provides meta data which control functions of a content rendering device according to the genre of content;
a combiner which combines the content source with the meta data source to generate a composite data set;
a broadcast device which broadcasts the composite data set;
a receiver which receives the composite data set;
a parser which parses the composite data set into the content and the meta data;
a meta data processor which generates control signals which control the content rendering device, in response to the meta data; and
the content rendering device which renders the content according to the control signals.

24. The system of claim 23, wherein the composite data set is broadcast data.
